(19) United States
(12) Patent Application Publication
(10) Pub. No.: US 2002/0183983 A1
(43) Pub. Date: Dec. 5, 2002

(54) Method and system for designing a building

(76) Inventors: Sharon Ehrlich, Kfar-Vitkin (IL); Tal Ehrlich, Kfar-Vitkin (IL)

Correspondence Address: FITCH EVEN TABIN AND FLANNERY, 120 SOUTH LA SALLE STREET, SUITE 1600, CHICAGO, IL, 60603-3406, US

(21) Appl. No.: 09/870,119

(22) Filed: May 30, 2001

(51) Int. Cl. G06F 17/50

(52) U.S. Cl. 703/1

(57) ABSTRACT

A method and system for evaluating a composite developmental plan of a building, where the composite plan indicates a simultaneous arrangement of a first delivery system and a second delivery system in the building. A standard is provided specifying a minimal distance that must exist between any element of the first system and any element of the second system. For each pair of a first element present in the first system and a second element present in the second system, it is determined whether the distance between first and second elements in the composite plan is greater than the first distance.

### FIELD OF THE INVENTION

This invention relates to methods for designing a building.

### BACKGROUND OF THE INVENTION

A modern building contains several distribution systems for channeling gases, liquids and electricity throughout the building. Such distribution systems include a plumbing system, electrical system, and heating and air conditioning systems. Each distribution system consists of one or more elements. For example, elements in a plumbing system may include pipes of a particular diameter, faucets, drains, etc.

Governmental bodies have legislated building codes that establish standards that a delivery system must comply with. Insurance companies as well as the building industry itself may require compliance with standards that are more stringent than the relevant government codes. U.S. Pat. No. 4,964,060 to Hartsog discloses a computer-aided building plan review system for determining from a building plan whether a delivery system complies with applicable standards. A building plan is input into a processor that compares a delivery system included in the plan with relevant standards stored in a memory.

In addition to building codes regulating a particular delivery system, codes may also exist regulating inter-relationships between two systems. A code may stipulate a minimum distance between an element in one system and any element in another system. For example, a code may specify a minimum distance between electrical wires and water pipes in a building. Generally, an architect or a general contractor designs the building elements (beams, walls, joists, etc.) Spaces are allocated in the building design for receiving the various delivery systems. The architect, however, does not specify how the various delivery systems are to be arranged within the spaces. It is thus left to the sub-contractor of each system to install his system within these spaces. This may lead to a haphazard arrangement of the systems in the spaces, determined by the order in which the systems are installed, and bow each subcontractor deals with facts already created in the spaces by the systems previously installed. This limits the ability of a sub-contractor to completely plan the system prior to its installation because logistical problems arise which can only be solved at the time of installation. The need for on-site designing of the system increases the time required for the installation land the amount of materials that must be allocated for the installation. Moreover, the final arrangement of the systems in the spaces may not comply with building codes regulating spatial relationships between the various systems in the building.

### SUMMARY OF THE INVENTION

The present invention provides a method and system for arranging delivery systems in a building during the design stage of the building so that building standards specifying spatial relationships between any pair of systems are complied with.

In accordance with the invention, a development plan is provided for each system. The development plan is typically provided by the sub-contractor who is to install the system in the building. The development plan shows the installation of the system in the spaces allocated for the system by the architect or main contractor. The development plans are input to a data processing system. A memory included in the processing system contains data indicative of building standards where each standard is applicable to a pair of delivery systems. For each pair of delivery systems, a standard specifies a first distance that is the minimal allowable distance that must exist between any element of the first system and any element of the second system. An arrangement of the two systems in which the distance between an element of one of the systems and an element of the other system is less than the first distance is unacceptable. The standard may also specify a second distance that is greater than the first distance. In this case, a distance between an element of one of the systems and an element of the second system is greater than the first distance but less than a second is allowable, however, it is preferable that the minimal distance between the two elements be greater than the second distance. The memory also stores a control program that generates a composite developmental plan from any two input developmental plans. The composite plan presents the two systems as they would appear if each system were to be installed according to its developmental plan. The control program also evaluates a composite plan according the standard applicable to the pair of systems in, the composite. A processor receives from the memory two input development plans as well as the applicable standard and runs the control program. An output means such as a CRT or printer is connected to the processor to display the composite plan and the evaluation of the plan produced by the control program. The output of the evaluation may consist of indicating for each pair of element, one element from each system, whether the distance between the two elements is below the first distance, and hence not allowable. If a second distance has been specified, the evaluation may consist of indicating whether the distance between the two elements is between the first and second distances (hence allowable but not desirable) or above the second distance.

If the evaluation of a composite plan shows that the distance between an element in the first system and an element of the second system is below the first distance, or between the first and second distances, a user may then alter the arrangement of elements in the original developmental plan, of one or both of the systems in order to bring the two systems into conformity with the standard. Moving an element of a system in the composite plan is most conveniently accomplished using a computer mouse and drag and drop technology. The new arrangement of the two delivery systems is then evaluated according to the applicable standard. The process of moving a component in the composite and evaluating the modified composite may be repeated as many times as necessary until an arrangement of each of the systems is found so that the pair of systems complies with the applicable standards.

A hierarchy may be established to determine the order in which pairs of systems are evaluated by the control program. The first and second systems in the hierarchy are first evaluated, and if necessary, one or both of the systems are rectified in order to bring the pair of systems into conformity with the applicable standard. The third system in the hierarchy would then be evaluated with the first system and separately with the second system. If necessary, any one of the first three systems are then rectified to bring each possible pair from among the three systems into conformity with the applicable standard. The process continues with at each stage evaluating the next system in the hierarchy with each of the systems before it in the hierarchy and rectifying any of these systems in order to bring each pair of these systems into conformity with the standard.

The invention comprises a method for evaluating a composite developmental plan, the composite plan being indicative of a simultaneous arrangement of a first delivery system and a second delivery system in a building, the first and second delivery systems being composed of elements, the method comprising steps of:

(a) providing a standard, the standard specifying a first distance; and

(b) for each pair of a first element present in the first system and a second element present in the second system, determining whether the distance between first and second elements in the composite plan, is greater than the first distance.

The invention further comprises a method for arranging n delivery systems in a building, the method comprising the steps of:

(a) providing a developmental plan for each of the n systems;

b) arranging the systems in a hierarchy, S₁ . . . , Sₖ . . . , Sₙ, where Sₖ is the k-th system in the hierarchy;

c) for k=2, . . . n

(ca) for i=1, . . . k−1;

(caa) providing a composite developmental plan of system Sₖ and system Sᵢ,

(cab) evaluating the composite plan by the method of the invention.

The invention still further comprises a method for arranging n delivery systems in a building, the method comprising the steps of:

(a) providing a developmental plan for each of the n systems;

(b) arranging the systems in a hierarchy, S₁, . . . Sₖ . . . Sₙ, where Sₖ is the k-th system in the hierarchy;

(c) for k=2, . . . n

(ca) for i=1, . . . k−1;

(caa) providing a composite developmental plan of system Sₖ and system Sᵢ,

(cab) evaluating the composite plan by the method of the invention.

The invention still further comprises a system for evaluating a composite developmental plan, the composite plan being indicative of a simultaneous arrangement of a first delivery system and a second delivery system in a building, the first and second delivery systems being composed of elements, the system comprising a processor configured to determine, for each pair of a first element present in the first system and a second element present in the second system, whether the distance between the first and second elements in the composite plan is greater than a first predetermined distance.

The invention still further comprises a system for arranging a delivery system in a building, each system having a developmental plan, the systems being arranged in a hierarchy S₁ . . . Sₖ . . . Sₙ, where Sₖ is the k-th system in the hierarchy, the system comprising a processor configured to:

for k=2, . . . , n

for i=1, . . . k−1

(a) producing a composite plan of the developmental plans of Sᵢ and Sₖ

(b) for each pair of a first element present in the i-th system and a second element present in the k-th system, determining whether the distance between the first and second elements in the composite plan is below a first predetermined distance Aᵢ₋ₖ.

The invention still further comprises a system for arranging a delivery system in a building, each system having a developmental plan, the systems being arranged in a hierarchy S₁ . . . Sₖ . . . Sₙ, where Sₖ is the k-th system in the hierarchy, the system comprising a processor configured to:

for k=2, . . . , n

for i=1, . . . k−1

(a) producing a composite plan of the developmental plans of Sᵢ and Sₖ

(b) for each pair of a first element present in the i-th system and a second element present in the k-th system, determining whether the distance between the first and second elements in the composite plan is below a second predetermined distance Aᵢ₋ₖ.

The invention still further comprises a program storage device readable by machine, tangibly embodying a program of instructions executable by the machine to perform method steps for assessing two or more developmental plans, each developmental plan being indicative of an arrangement of a delivery system in a building, the method comprising steps of:

(i) producing a composite developmental plan, the composite plan being indicative of spatial relationships among the delivery systems in the building;

(ii) determining whether the composite plan complies with one or more building standards.

The invention still further comprises a computer program product comprising a computer useable medium having computer readable program code embodied therein for assessing two or more developmental plans, each developmental plan being indicative of an arrangement of a delivery system in a building, the computer program product comprising:

computer readable program code for causing the computer to produce a composite developmental plan, the composite plan being indicative of spatial relationships among the delivery systems in the building;

computer readable program code for causing the computer to determine whether the composite plan complies with one or more building standards.

### BRIEF DESCRIPTION OF THE DRAWINGS

In order to understand the invention and to see how it may be carried out in practice, a preferred embodiment will now be described by way of non-limiting example only, with reference to the accompanying drawings, in which:

FIG. 1 shows a system for designing a building according to one embodiment of the invention;

FIG. 2a shows a flow chart diagram for carrying out the method of the invention and FIG. 2b shows screens displayed to the user at various stages of the method;

FIG. 3a shows a flow chart diagram for carrying out the generate composite option, and FIG. 3b shows screens presented to the user at various steps of the method.

FIG. 4a shows a flow chart diagram for executing the process composite plan option, and FIG. 4b shows screens displayed to the user on at various stages of this option.

### DETAILED DESCRIPTION OF THE INVENTION

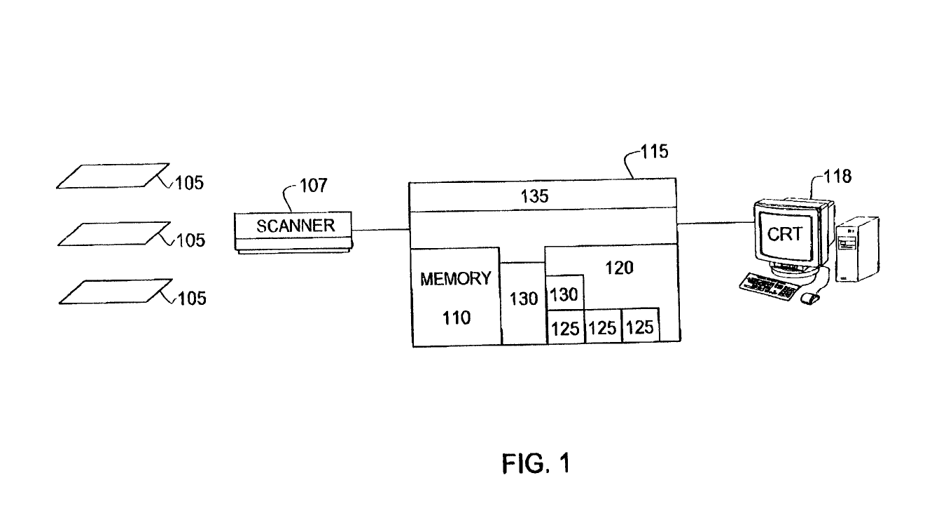

FIG. 1 shows a system for evaluating pairs of development plans in accordance with one embodiment of the invention. A scanner 107 scans developmental plans 105 and stores the scanning data in a memory 110 of a processor 115. The processor 115 may optionally convert any of the input developmental plans 105 into a predetermined format. This eases comparison of the plans 105. The processor 115 may call up scanning data from the memory 110 obtained from a plan and display plan 105 on a CRT 118 in either a two- or three-dimensional view. A memory 120 contains a composite plan generating program that generates a composite of two or more developmental plans 105. The memory 120 also contains files storing data indicative of standards 125 applicable to pairs of delivery systems. A standard applicable to a particular pair of systems specifies a first distance that is the minimal distance that must exist between any element from one of the two systems and any element from the other system. The standard may optionally specify a second distance that is greater than the first distance. The distance between an element of one of the systems and an element of the other system may be between the first and second distances, but it is preferable that the distance between them be greater than the second distance. The memory 120 also contains files storing a plan check program 130 that evaluates data is indicative of composite plan against the standard applicable to the two systems shown in the composite. A processor 135 receives scanning data of two plans 105 and generates a composite of the plans using the composite generating program. The composite plan may be stored in the memory 110 and may be displayed on the CRT 118. The processor 135 then checks the composite plan against the applicable standard to the two systems using the plan check program. If in the composite plan, the distance between an element of one of the systems and an element of the second system is less than the first distance or is between the first and second distances as revealed by the plan check program, this is indicated by the check program on the CRT.

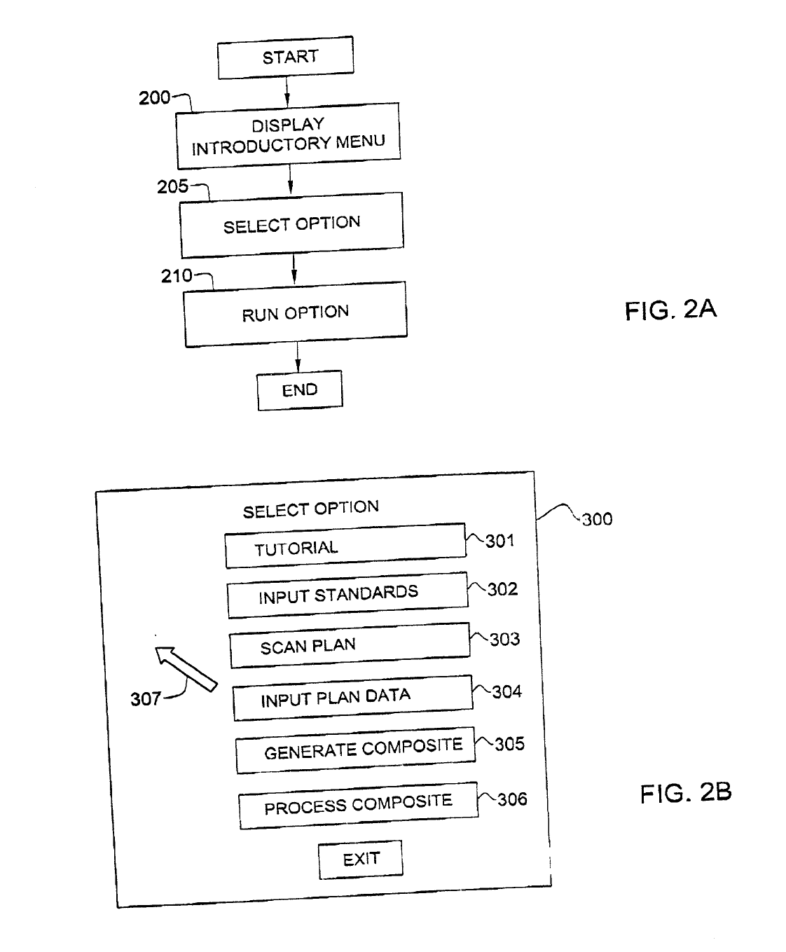

FIG. 2a shows a flow chart diagram for carrying out the method of the invention and FIG. 2b shows a screen 300 displayed to the user on the CRT 118 at various stages of the method.

In step 200, the screen 300 is displayed showing an introductory menu. The menu presents a set of options for performing the various tasks executable by the program. One option is a tutorial 301 that allows the user to obtain an explanation of the operation of the software package. A second option is inputting standards applicable to pairs of delivery systems 302. The user may also opt for scanning a developmental plan 303, or in the event that a plan is provided by a sub-contractor in a data storage device such as a computer disk, inputting the data to the memory 304. Other options include generating a composite plan of two or more plans 305 or processing a composite plan 306.

In step 205 the user selects an option from among the options presented to him on the options screen 300. This is done by the user bringing a cursor to one of the buttons representing an option using a computer inputs device such as a computer mouse and clicking the mouse. In step 210 the selected option is run.

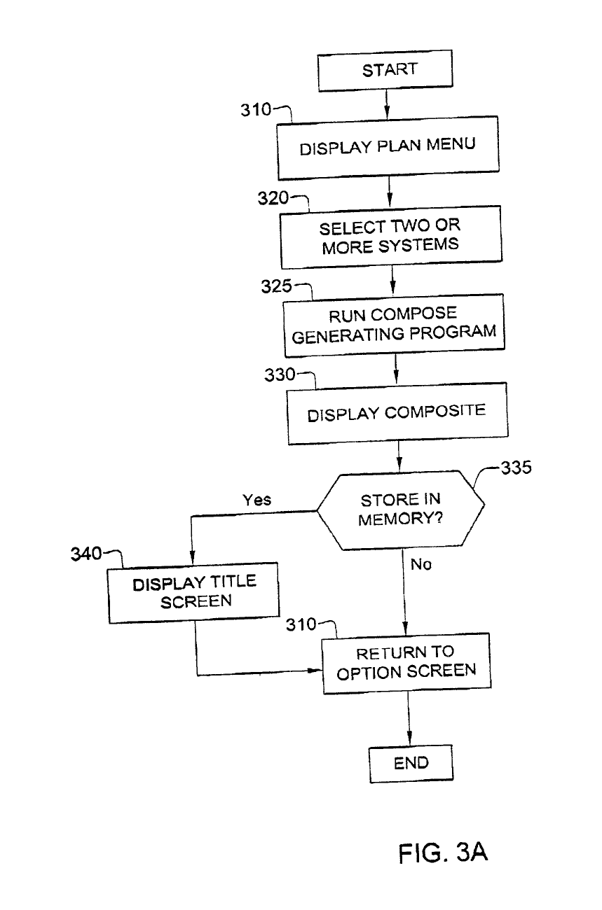

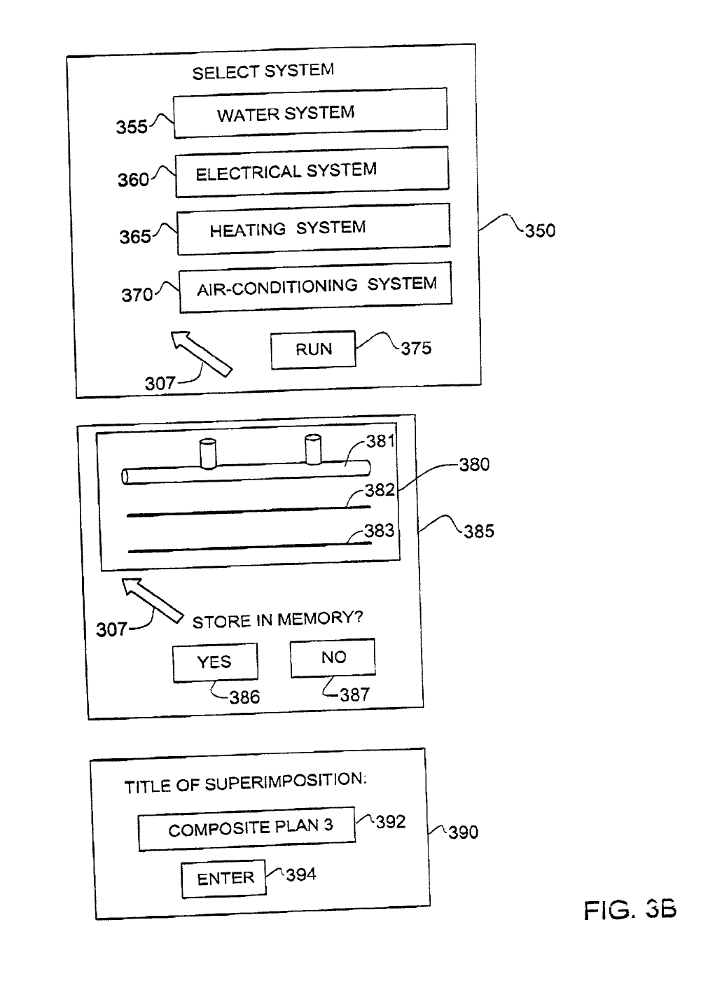

FIG. 3a shows a flow chart diagram for carrying out the generate composite option 305, and FIG. 3b shows screens presented on the CRT 118 to the user at various steps of the method. In step 310, a plan menu 350 is displayed. The plan menu 350 presents a list of systems whose developmental plan is stored in the memory. The systems include, for example, the water system 355, the electrical system 360, the heating system 365 and the air conditioning system 370.

In step 320, the user selects two systems from among the systems appearing in the plan menu 350. A system is selected by the user bringing the cursor 307 to the system and clicking the mouse. After the two systems have been selected, the user presses the run button 375 (step 325) in order to run the composite plan generating program. In step 330, the generated composite plan 380 is displayed on the CRT as shown in the screen 385. In this example, screen 380 shows a composite plan of a plumbing system (comprising a pipe 381), and an electrical plan (showing electrical wires 382, 383, 384). The user is then prompted in step 335 whether to store the composite plan 380 in the memory. The user makes his selection by clicking the appropriate button (yes 386 or no 387).

If the user clicks the yes button, (step 340), a screen 390 appears on the CRT 118 prompting the user to input a title for the composite plan in a field 392. The user does this using his computer keyboard and then presses the enter button 394. The option screen 300 is then displayed on the CRT (step 345). If the user clicks the no button in step 335, the option screen is then displayed on the CRT (step 345).

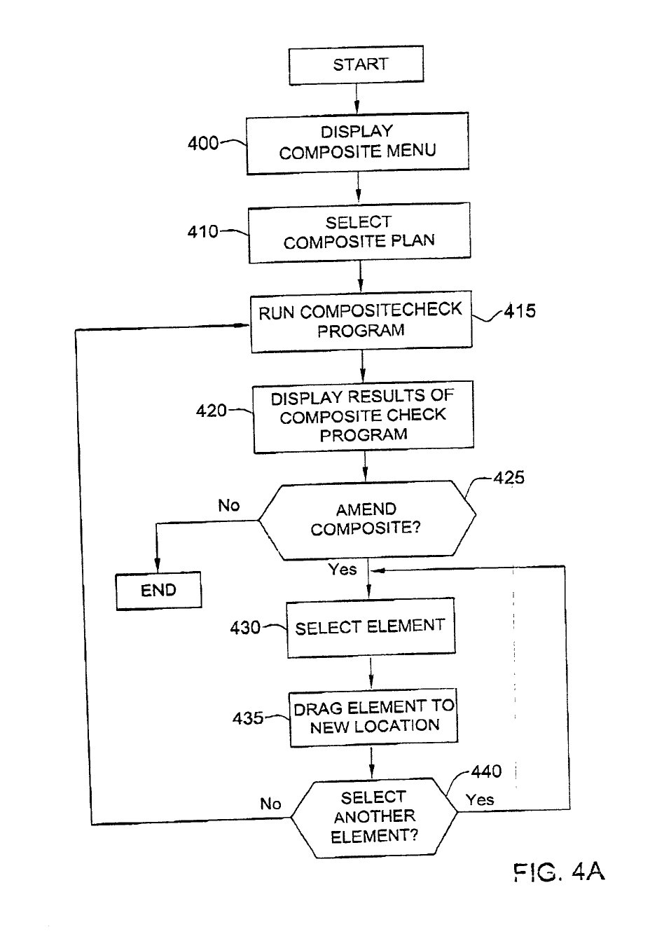

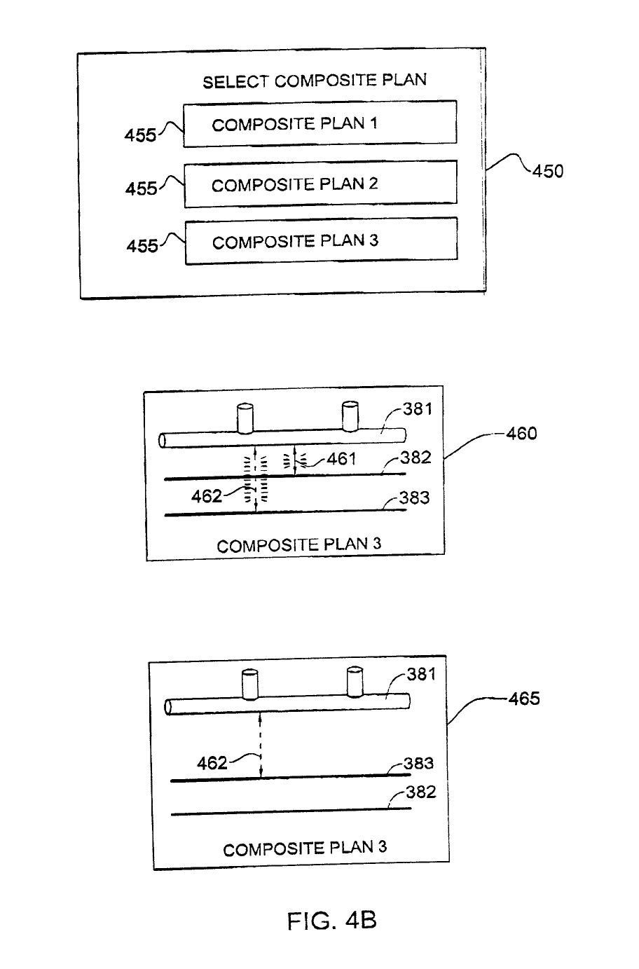

FIG. 4a shows a flow chart diagram for executing the process composite plan option 306, and FIG. 4b shows screens displayed to the user on the CRT 118 at various stages of this option. In step 400 the composite menu 450 is displayed on the CRT. The composite menu 450 displays a list of all composite plans stored in the memory. The user then selects from among the displayed composite plans the plan to be analyzed by the composite check program (step 410) by pressing the appropriate button 455 on the composite screen 450. The composite check program then runs (step 415), and the results of the program are displayed on the CRT (step 420).

The results are displayed by means of a screen 460 displayed on the CRT 118 showing the composite plan in which elements or pairs of elements that fail to comply with a standard are highlighted. For example, in screen 460, the distance between the water pipe 381 and the electric wire 382 is below the first distance as specified by the standard applicable to a plumbing system and an electrical system. This is indicated by an arrow 461. The distance between water pipe 381 and electric wire 382 is between the first and second distances specified by the standard. This is indicated by a broken arrow 462. In step 425 the user is prompted to decide whether to amend any of the systems appearing in the composite. If yes, the user is prompted to select an element of a system appearing in the screen 460 (step 430). The user selects an element with his computer mouse and drags it to a new location in the composite plan (step 435). For example, the user may decide to move the electrical wire 382 away from the water pipe 381, so that the composite plan appears as a distance between that shown in screen 465. The distance between the electrical wire 382 and the water pipe 381 in screen 465 is greater than the second distance specified by the applicable standard. The arrow 461 has therefore disappeared and has not been replaced with another arrow. The user is then asked whether he wishes to move another element in the composite plan (step 440). If yes, the process returns to step 430 with the selection of a new element. If no, the process returns to step 415 with execution of the composite check program applied to the amended composite plan. If at step 425 the user decides not to further amend the composite, the amended composite plan is stored in the memory.

It will also be understood that the system according to the invention may be a suitably programmed computer. Likewise, the invention contemplates a computer program being readable by a computer for executing the method of the invention. The invention further contemplates a machine-readable memory tangibly embodying a program of instructions executable by the machine for executing the method of the invention.

1. A method for evaluating a composite developmental plan, the composite plan being indicative of a simultaneous arrangement of a first delivery system and a second delivery system in a building, the first and second delivery systems being composed of elements, the method comprising steps of:
(a) providing a standard, the standard specifying a first distance; and
(b) for each pair of a first element present in the first system and a second element present in the second system, determining whether the distance between first and second elements in the composite plan, is greater than the first distance.

2. The method of claim 1 wherein the composite plan is provided by superimposing a developmental plan for the first system and a developmental plan of a second system.

3. The method of claim 1, wherein the standard further specifies a second distance, the second distance being greater than the first distance, and the method further comprises a step of determining for each pair of a first element present in the first system and a second element present in the second system, whether the distance between first and second elements is between the first and second distance.

4. The method of claim 1, further comprising a step, for one or more pairs of a first element present in the first system and a second element in the second system for which the distance between the first and second elements is less than the first distance, of rectifying the composite plan to produce a rectified composite plan in which the distance between first and second elements in the composite plan is greater than the first distance.

5. The method of claim 3, further comprising a step, for one or more pairs of a first element present in the first system and a second element in the second system for which the distance between the first and second element is less than the second distance, of rectifying the composite plan to produce a rectified composite plan, in which the distance between first and second elements in the composite plan is greater than the second distance.

6. A method for arranging n delivery systems in a building, the method comprising the steps of:
(a) providing a developmental plan for each of the n systems;
(b) arranging the systems in a hierarchy, S₁, . . . , Sₖ . . . , Sₙ, where Sₖ is the k-th system in the hierarchy;
(c) fork=2, . . . n
(ca) for i=1, . . . k−1;
(caa) providing a composite developmental plan of system Sₖ and system Sᵢ,
(cab) evaluating the composite plan by the method of the invention.

7. The method of claim 6 further comprising a step (cac) for one or more values of k for which a first element in the system Sₖ and a second element in the system Sᵢ, for which the distance between the first and second elements is less than the first distance, of rectifying the composite plan to produce a rectified composite plan in which the distance between the first and second elements in the composite plan is greater than the first distance.

8. A method for arranging n delivery systems in a building, the method comprising the steps of:
(a) providing a developmental plan for each of the n systems;
(b) arranging the systems in a hierarchy, Sᵢ, . . . Sₖ, . . . Sₙ, where Sₖ is the k-th system in the hierarchy;
(c) for k=2, . . . n
(ca) for i=1, . . . k−1;
(caa) providing a composite developmental plan of system Sₖ and system Sᵢ,
(cab) evaluating the composite plan by the method of the invention.

9. The method of claim 8 further comprising a step (cac) for one or more values of k for which a first element in the system Sₖ and a second element in the system Sᵢ, for which the distance between the first and second elements is less than the second distance, of rectifying the composite plan to produce a rectified composite plan in which the distance between the first and second elements in the composite plan is greater than the second distance.

10. A system for evaluating a composite developmental plan, the composite plan being indicative of a simultaneous arrangement of a first delivery system and a second delivery system in a building, the first and second delivery systems being composed of elements, the system comprising a processor configured to determine, for each pair of a first element present in the first system and a second element present in the second system, whether the distance between the first and second elements in the composite plan is greater than a first predetermined distance.

11. The system according to claim 10 wherein the processor is further configured to generate a composite plan from two development plans.

12. The system according to claim 10 wherein the processor is further configured to determine, for each pair of a first element present in the first system and a second element present in the second system, whether the distance between the first and second elements is between the first predetermined distance and less than a second predetermined distance.

13. The system according to claim 10, wherein the processor is further configured, for one or more pairs of a first element present in the first system and a second element present in the second system for which the distance in the composite plan between the first and second element is less than the first predetermined distance, to rectify the composite plan so as to produce a rectified composite plan in which the distance between the first and second elements in the composite plan is greater than the first distance.

14. The system according to claim 12 wherein the processor is further configured, for one or more pairs of a first element present in the first system and a second element present in the second system for which the distance in the composite plan between the first and second element is less than the second predetermined distance, to rectify the composite plan so as to produce a rectified composite plan in which the distance between the first and second elements in the rectified composite plan is greater than the second distance.

15. A system for arranging a delivery system in a building, each system having a developmental plan, the systems being arranged in a hierarchy S₁ . . . Sₖ . . . Sₙ, where Sₖ is the k-th system in the hierarchy, the system comprising a processor configured to:
for k=2, . . . , n
for i=1, . . . k−1
(a) producing a composite plan of the developmental plans of Sᵢ and Sₖ; and
(b) for each pair of a first element present in the i-th system and a second element present in the k-th system, determining whether the distance between the first and second elements in the composite plan is below a first predetermined distance A_{i—k}.

16. A system for arranging a delivery system in a building, each system having a developmental plan, the systems being arranged in a hierarchy S₁ . . . Sₖ . . . Sₙ, where Sₖ is the k-th system in the hierarchy, the system comprising a processor configured to:
for k=2, . . . , n
for i=1, . . . k−1
(a) producing a composite plan of the developmental plans of Sᵢ and Sₖ; and
(b) for each pair of a first element present in the i-th system and a second element present in the k-th system, determining whether the distance between the first and second elements in the composite plan is below a second predetermined distance A_{i—k}.

17. The system according to claim 10 further comprising a memory for storing data indicative of one or more developmental plans.

18. The system according to claim 15, further comprising a memory for storing data indicative of one or more developmental plans.

19. The system according to claim 16, further comprising a memory for storing data indicative of one or more developmental plans.

20. The method according to claim 10 further comprising an input device for inputting data indicative of one or more developmental plans into the memory.

21. The method according to claim 15 further comprising an input device for inputting data indicative of one or more developmental plans into the memory.

22. The method according to claim 16 further comprising an input device for inputting data indicative of one or more developmental plans into the memory.

23. The method according to claim 10 further comprising a memory for storing data indicative of one or more composite developmental plans.

24. The method according to claim 15 further comprising a memory for storing data indicative of one or more composite developmental plans.

25. The method according to claim 16 further comprising a memory for storing data indicative of one or more composite developmental plans.

26. The system according to claim 10 further comprising a display device for displaying a developmental plan or a composite developmental plan.

27. The system according to claim 15 further comprising a display device for displaying a developmental plan or a composite developmental plan.

28. The system according to claim 16 further comprising at display device for displaying a developmental plan or a composite developmental plan.

29. The system according to claim 27 wherein the display device is a CRT.

30. The system according to claim 27 wherein the processor is further configured to indicate in a displayed composite developmental plan elements in the plan that do not comply with a standard.

31. The method according to claim 27 further comprising an input device for amending a displayed composite developmental plan.

32. The method according to claim 31 wherein the input device is a computer mouse and a displayed composite developmental plan is amended using the mouse to drag one or more elements in the displayed plan to a new location in the plan.

33. A program storage device readable by machine, tangibly embodying a program of instructions executable by the machine to perform method steps for assessing two or more developmental plans, each developmental plan being indicative of an arrangement of a delivery system in a building, the method comprising steps of:
(i) producing a composite developmental plan, the composite plan being indicative of spatial relationships among the delivery systems in the building;
(ii) determining whether the composite plan complies with one or more building standards.

34. A computer program product comprising a computer useable medium having computer readable program code embodied therein for assessing two or more developmental plans, each developmental plan being indicative of an arrangement of a delivery system in a building, the computer program product comprising:
computer readable program code for causing the computer to produce a composite developmental plan, the composite plan being indicative of spatial relationships among the delivery systems in the building;
computer readable program code for causing the computer to determine whether the composite plan complies with one or more building standards.
